(19) United States
(12) Patent Application Publication
(10) Pub. No.: US 2011/0250495 A1
(43) Pub. Date: Oct. 13, 2011

(54) Electrolyte Composition Electrochemical Cell Including A Contrast Agent And Method For Manufacturing Cells Using Same

(75) Inventors: Andrew Webber, Avon Lake, OH (US); Bryce J. Brown, Wellington, OH (US)

(73) Assignee: EVEREADY BATTERY COMPANY, INC., St. Louis, MO (US)

(21) Appl. No.: 12/758,055

(22) Filed: Apr. 12, 2010

(51) Int. Cl. H01M 6/04; H01M 4/82

(52) U.S. Cl. 429/199; 429/188; 29/623.2

(57) ABSTRACT

An electrolyte composition including a detectable contrast agent and an electrochemical cell including the electrolyte composition, wherein the contrast agent allows for detection of spillage or leakage of electrolyte during or after cell construction. In some embodiments, the contrast agent is able to change the color intensity of the electrolyte composition over time after addition to the cell. Methods for detecting spillage or leakage of the contrast agent-containing electrolyte composition during cell construction are disclosed.

### FIELD OF THE INVENTION

The present invention relates to an electrolyte composition including a detectable contrast agent and an electrochemical cell including the electrolyte composition, wherein the contrast agent allows for detection of spillage or leakage of electrolyte during or after cell construction. In some embodiments, the contrast agent is able to change the color intensity of the electrolyte composition over time. Methods for detecting spillage or leakage of the contrast agent-containing electrolyte composition during cell construction are disclosed.

### BACKGROUND OF THE INVENTION

Various electrochemical cells contain an electrolyte composition, in particular a nonaqueous electrolyte composition, within the cell container and in contact with positive and negative electrodes. The electrolyte compositions are often capable of corroding the outer surface of the cell container. The corrosion problem can be exacerbated in relatively high humidity environments. The electrolyte composition can contact the container's outer surface during manufacturing, for example during filling of the container with the composition by spilling, splashing or even machine error. Additionally, after an electrochemical cell has been assembled, seal failure or other issue(s) may cause the electrolyte composition to leak from within the cell container and contact the outer surface of the container.

In order to detect leakage or presence of an electrolyte composition on the outer surface of an electrochemical cell container, a few solutions have been proposed.

U.S. Pat. No. 7,585,594 and U.S. Publication No. 2010/0035130 relate to an electrolyte with an indicator, such as a dye, for reportedly detecting leakage from an electrochemical energy storage device. Also provided is a method of making such an electrolyte with indicator; a device that incorporates such an electrolyte with indicator; a method of manufacturing an electronic or electrical system that incorporates such a device; and a method of reportedly detecting the leakage of electrolyte from a battery or capacitor.

U.S. Pat. No. 4,999,265 relates to an electrolytic composition which comprises an alkaline electrolyte mixture and a fluorescent additive. The fluorescent additive should be stable at the pH of the electrolyte mixture. In the preferred embodiment the fluorescent additive is a pyrene compound at a concentration of 0.1% by weight of the final composition. An electrochemical cell is also disclosed which incorporates the electrolytic composition. A method for detecting spillage or leakage of electrolyte during manufacture of such an electrochemical cell is also disclosed utilizing the fluorescent character of the electrolytic composition.

Japanese Publication No. 58-068880 relates to a pH-indicator solution such as cresol red that is sprayed in super fine mist form at the sealing part of a battery. As cresol red serving as pH-indicator has the pH-color-changing ranges at two positions, liquid-leak is judged through the color change from yellow to red in the higher pH-color-changing range (pH 7.2-8.8). The concentration of cresol red is preferably 0.00˜0.5% and the composition of the mixed solution is preferably 70:30˜30:70 by weight % in water:ethanol.

Japanese Publication No. 57-148878 relates to X-rays sent from an X-ray tube that are radiated on the sealed portion of a cell. Fluorescent radiation excited by the cell is reduced to parallel rays of light by a collimator, before being applied to a spectrocrystal. The angle θ of the spectrocrystal has been so adjusted that it diffracts the fluorescent radiations of rubidium (Rb), cesium (Cs) only. The X-rays diffracted by the spectrocrystal are detected by an X-ray detector. Accordingly, the installation of the apparatus in the process of inspecting the liquid leakage of cells reportedly makes it possible to detect liquid leakage.

Additional problems can arise when an electrochemical cell includes an electrolyte composition having an additive that aids in leakage detection added to the cell because the additive must be soluble in and compatible with the electrolyte composition and the positive and negative electrode materials, while also being provided in sufficiently low concentrations so as to be safe, economical and practical. Also, the additive component must not appreciably affect cell rate performance and also must be able to be detected by detection means, whether the naked eye or an optical system (such as a camera). Most importantly, the additive must not appreciably degrade the shelf life of the battery and/or its ability to withstand high temperature storage, especially for batteries that have very long shelf life as is common for many nonaqueous lithium batteries.

Ideally, the additive would function as an effective agent both when dissolved in the liquid electrolyte and also after the solvents in the electrolyte had evaporated off leaving just the salt and additive residue, such that, for example, the residue can be viewed on an outer surface of an electrochemical cell container.

### SUMMARY OF THE INVENTION

In view of the above, it would be desirable to provide a reliable system for detecting the presence of an electrolyte composition on an outer surface of an electrochemical cell to prevent or minimize corrosion, and further to prevent contaminated cells from reaching a retailer or consumer.

It is also desirable to provide an electrolyte composition, preferably a nonaqueous electrolyte composition, including a contrast agent that has a desirable color intensity and is visible, in wet or dry form, when present on the outer surface of the cell container. Additionally, the contrast agent does not substantially affect cell rate performance and is compatible with the electrolyte composition, preferably a nonaqueous electrolyte composition in one embodiment; and the positive and negative electrodes.

An electrochemical cell, preferably a primary cell, is provided with an electrolyte composition, preferably a nonaqueous electrolyte composition, and a contrast agent that allows for detection of the composition when present on an outer surface of the cell container. Preferably, the contrast agent provides the electrolyte composition with a color intensity that lasts for a period of time, for example hours, days or weeks, whereafter the composition exhibits a second color intensity. The initial color intensity is maintained until after the electrolyte composition is added to a cell container and the cell assembly process is completed and the sealed cell is inspected. For example, the contrast agent could either absorb into either electrodes or other cell component or actually react with another cell component to change its appearance. In some cases, the contrast agent will cease to be visible after a set period of time, thereby optimizing the invention for use in a production setting without disrupting the consumer/end user's experience.

The contrast agent may also be introduced to the cell in liquid or solid form separately from the electrolyte, preferably integrated into one of the electrodes or other cell components. In the event the contrast agent is introduced to the cell other than through the electrolyte composition, the contrast agent must be soluble enough in the electrolyte to disperse within the cell in order to effect this particular embodiment of the invention.

In addition, an electrochemical cell, preferably a primary cell, having a lithium negative electrode that includes metallic lithium or a lithium alloy and iron disulfide as the electrochemically active materials, is contemplated. As above, the cell includes a nonaqueous electrolyte composition comprising the contrast agent.

A method for determining if an electrolyte composition is present on an outer surface of a container is also contemplated. In such cases, cells detected by this method can be rejected, such as when container exhibits leakage, or can be processed to remove the electrolyte composition from the surface of the container, for example by washing the contaminated cells. Accordingly, the overall manufacturing process may be made more efficient and the resulting product more reliable and desirable to the end user.

Accordingly, an electrolyte composition is disclosed comprising an electrolyte mixture suitable for use in an electrochemical cell, preferably a nonaqueous cell, and a contrast agent comprising an azo compound. In a preferred embodiment, the electrolyte comprises a nonaqueous solvent and a solute, and wherein the contrast agent has one of the following formulae:

R₁—N═N—R₂ (formula 1)

or

R₁—(N═N—R₂)ₙ—N═N—R₃ (formula 2)

wherein n is 1 to about 5 and wherein R₁, R₂, and R₃ each comprise one or more aliphatic groups, one or more aryl groups, or one or more arylalkyl groups or a combination thereof, with each group optionally containing one or more substituent groups. In a further embodiment the electrolyte composition comprising the contrast agent has a first color intensity upon combination of the contrast agent to the remaining components of the composition, the composition capable of exhibiting a second color intensity at a time after the combination of the contrast agent and the remaining components of the mixture.

Another aspect of the invention is an electrochemical cell, comprising a container comprising a positive electrode, a negative electrode, a contrast agent comprising an azo compound, and an electrolyte composition comprising a solute and a solvent.

A further aspect of the present invention is a method for detecting the presence of an electrolyte composition on an outer surface of a container of an electrochemical cell, comprising the steps of adding an electrolyte composition to the electrochemical cell container, the electrolyte composition comprising a solvent, a solute, and a contrast agent including an azo compound; sealing the electrochemical cell; and inspecting the outer surface of the electrochemical cell and determining if the electrolyte composition is present. This method also includes the use of an electrolyte composition, independent of any particular contrast agent, that has a color intensity that changes over time, so as to provide a window of time in which to identify and take corrective action for cells exhibiting the presence of electrolyte on an outer surface.

Still another aspect of the invention is an electrochemical cell comprising a container comprising a positive electrode, a negative electrode, and an electrolyte composition comprising a contrast agent, a solvent and a solute, wherein the electrolyte composition exhibits a first color intensity upon combination of the contrast agent and the solvent and the solute of the electrolyte composition whereafter the electrolyte composition is a capable of exhibiting a second color intensity at a time after said combination. Preferably, the solvent includes one or more nonaqueous solvents, one or more organic solvents or one or more aqueous solutions.

### BRIEF DESCRIPTION OF THE DRAWINGS

The invention will be better understood and other features and advantages will become apparent by reading the Detailed Description of the Invention, taken together with the drawings, wherein:

FIG. 1 is a cross-sectional elevational view of one embodiment of an electrochemical cell of the present invention including an electrolyte composition comprising a contrast agent. Note that the liquid electrolyte itself is not shown. Typically much, and in some cases most, of the electrolyte is absorbed into the structures of one or both electrodes and the separator material. In addition, there may be an excess pool of electrolyte at the bottom of cell; and

FIG. 2 is a graph illustrating excellent amperage values for experimental cell lots including a contrast agent as compared to a control lot free of a contrast agent.

### DETAILED DESCRIPTION OF THE INVENTION

Electrolyte compositions of the invention include a solute (i.e. salt), a solvent and preferably a contrast agent. The nonaqueous electrolyte compositions of the invention include a solute, a nonaqueous solvent, and a contrast agent. The electrochemical cells of the invention comprise a cell container in which the electrolyte composition is present along with a contrast agent, a positive electrode, preferably iron disulfide in a one embodiment; and a negative electrode, preferably including lithium or a lithium alloy in one embodiment.

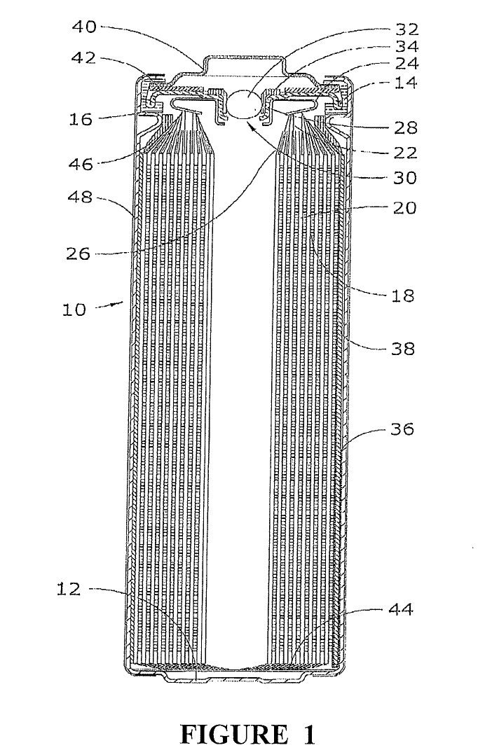

An example embodiment of an electrochemical cell is illustrated in FIG. 1. Cell 10 is a primary FR6 type cylindrical Li/FeS₂ cell. However, it is to be understood that, as described herein, the invention is applicable to other cell types, materials, and constructions, and the description regarding FR6 cells is not intended to be limiting. For example, bobbin-style, prismatic and coin cell constructions, utilizing various known battery chemistries, are or may be amenable to embodiments of the invention.

With reference to FIG. 1, Cell 10 has a housing that includes a container in the form of a can 12 with a closed bottom and an open top end that is closed with a cell cover 14 and a gasket 16. The can 12 has a bead or reduced diameter step near the top end to support the gasket 16 and cover 14. The gasket 16 is compressed between the can 12 and the cover 14 to seal an anode or negative electrode 18, a cathode or positive electrode 20 and electrolyte within the cell 10. The anode 18, cathode 20 and a separator 26 are spirally wound together into an electrode assembly. The cathode 20 has a metal current collector 22, which extends from the top end of the electrode assembly and is connected to the inner surface of the cover 14 with a contact spring 24. The anode 18 is electrically connected to the inner surface of the can 12 by a current collector such as a tab or metal lead 36. The lead 36 is fastened to the anode 18, extends from the bottom of the electrode assembly and is folded across the bottom and up along the side of the electrode assembly in one embodiment. The lead 36 may be welded, or make pressure contact with the inner surface of the side wall of the can 12 as shown. After the electrode assembly is wound, it can be held together before insertion by tooling in the manufacturing process, or the outer end of material (e.g., separator or polymer film outer wrap 38) can be fastened down, by heat sealing, gluing or taping, for example.

An insulating cone 46 can be located around the peripheral portion of the top of the electrode assembly to prevent the cathode current collector 22 from making contact with the can 12, and contact between the bottom edge of the cathode 20 and the bottom of the can 12 is prevented by the inward-folded extension of the separator 26 and an electrically insulating bottom disc 44 positioned in the bottom of can 12.

Cell 10 has a separate positive terminal cover 40, which is held in place by the inwardly crimped top edge of the can 12 and the gasket 16 and has one or more vent apertures (not shown). The can 12 serves as the negative contact terminal. An insulating jacket, such as an adhesive label 48, can be applied to the side wall of the can 12.

### Electrolyte Composition

Irrespective of the cell construction, the contrast agent of the electrolyte composition has several characteristics. Foremost, it must be compatible in the electrolyte composition and with the components of the positive and negative electrodes. The contrast agent should also have a color intensity that is detectable at least during the time the electrolyte composition is added to the cell and an inspection of the sealed or finished cell can be made to determine if any of the electrolyte composition, in one or more of wet and dry form, exists on the outer surface of the cell container. Indeed, irrespective of the exact chemical composition of the contrast agent, one embodiment of the inventive method contemplates the use of a contrast agent which changes color intensity to allow for detection during manufacturing; thereafter, the color intensity fades or disappears completely.

In a preferred embodiment, the contrast agents are azo compounds and have one or more R—N═N—R′ functional groups. The azo compounds generally have one of the following formulae:

R₁—N═N—R₂ (1) or

R₁N═N—R₂ₙN═N—R₃ (2)

wherein each R₁, R₂, and R₃, independently, comprise one or more aliphatic groups, one or more aryl groups, or one or more arylalkyl groups, or a combination thereof each optionally substituted with one or more substituent groups and wherein n is 1 to about 5. R₁, R₂ and R₃ are distinct groups and are not directly connected to each other, i.e. such as in cyclic form. In preferred embodiments and in order for such materials to have a visible color, it is usually desirable that one of more of the R groups contain an aryl (e.g., —C₆H₄—) and/or alkenyl (e.g., —CH═CH—) group such that they form a conjugated chain of alternating single and double bonds with the azo linkage(s). As described more fully below, it will be understood that these aryl and alkenyl groups do not necessarily need to encompass only hydrogen groups bonded to the carbon, and other substitutions in place of hydrogen may be possible thereon.

Examples of aliphatic groups include, but are not limited to, linear or branched groups, having from 1 to about 15 carbon atoms, e.g. methyl, ethyl, propyl, isopropyl, butyl, isobutyl, and tertbutyl etc. groups.

The term “aryl” as utilized herein refers to a cyclic group, and the term “arylalkyl” refers to an aliphatic group connected to a cyclic group. Examples of aryl groups include, but are not limited to cyclic rings, optionally including heteroatoms, having from 5 or 6 to about 20 carbon atoms each. Nonlimiting specific examples include benzene derivatives such as a phenyl group and fused five and/or six or more member rings, e.g. naphthalene, anthracene, indene, indacene, azulene, acenaphthylene and fluorene. Suitable specific arylalkyl groups include, but are not limited to, tolyl and xylyl groups.

Substituent groups that are optionally connected to one or more of the aliphatic, aryl and arylakyl groups include, but are not limited to a hydroxyl group; a carbonyl group such as an aldehyde or a ketone; an acid group; an ester group; an amide group; an amine group; a nitrile group, such as cyano group; a nitro group; a halogen; peroxy group, sulfonate or a salt thereof where applicable.

In one preferred embodiment, at least one of R₁, R₂ and R₃ is a naphthalenol group, such as 2-naphthalenol.

One preferred contrast agent of the present invention has the following formula:

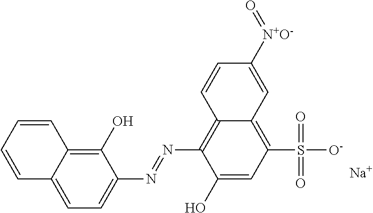

and is available as Eriochrome Black T, also known as, sodium (4Z)-4-[(1-hydroxynaphthalen-2-yl-hydrazinylidene]-7-nitro-3-oxo-Y-naphthalene-1-sulfonate. Eriochrome Black T is available from numerous commercial sources, for example J. T. Baker of Phillipsburg, N.J.; Fisher Scientific of Fair Lawn, N.J.; and Sigma-Aldrich Corp. of St. Louis, Mo. As Eriochrome Black T is generally utilized as a complexometric indicator in titrations that undergoes a color change in the presence of specific metal ions, it is unexpected that the same would be a suitable contrast agent for electrochemical cells including a nonaqueous electrolyte. This agent is normally used in aqueous solutions and its reactions are pH dependent. It is therefore especially surprising that this agent provides a useful color in nonaqueous electrolytes, as pH has relatively little meaning in such systems. Likewise, the discovery that a detectable color may be provided in the solid state with dried electrolyte salt(s), which can be precipitated as solvents evaporate from electrolyte that has leaked from a battery or has been otherwise spilled, is also unexpected.

In a further embodiment, the contrast agent is a 2-naphthalenol(phenylazo)phenyl azo alkyl derivative, such as RD-58 from American Gas and Chemical Company of Northvale, N.J. Thus in formula (2) above n is 1.

In yet a further embodiment, the contrast agent is 2-naphthalenol, 1-[[4-(phenylazo)phenyl]azo], wherein in formula (2) above n is 1. Another name of the compound is Solvent Red 23. The contrast agent is illustrated by the following formula:

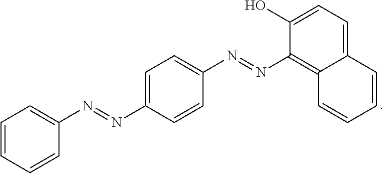

It is believed that one important chromophore present in the contrast agent that provides for a desired color intensity in the electrolyte compositions of the present invention at least under ambient conditions is the azo group, —N═N—. Also, preferred contrast agents each include, in addition to the azo group, a napthalenol group, such as 2-naphthalenol. Other similar conjugated groups, particularly as in the examples described above, may also be possible.

Absent actual experimentation, it is generally not known how a particular additive dissolved in an electrolyte will behave or react after exposure to and storage in a particular electrochemical cell system. For example, the additive must generally be stable to both the anode (reductant) and cathode (oxidant), usually for many years, and in cases where the additive might change color or fade with prolonged storage time in the cell, any change must not be at the expense of cell functionality or additive efficacy. Moreover, strong interactions between components of cells—especially those between the electrolyte and electrode surfaces—often involve complex chemistry that is poorly understood. Thus, electrolytes are a highly unpredictable art, and one cannot generally predict the utility of additives in a particular system in the absence of specific cell testing.

The amount of the contrast agent utilized in electrolyte composition depends on various factors including the types of solvent and solute utilized in the electrolyte composition, the particular contrast agent utilized, the desired level of color intensity, method used to detect the color, and the compatibility of the contrast agent with the cell components.

The contrast agent is present in an effective amount in order to provide desired color intensity in the electrolyte composition for a desired period of time and generally from about 10 to about 50,000 parts per million (ppm), desirably from 100 to about 5,000, and preferably from about 200 to about 600 ppm by weight of the electrolyte composition. Desirably, the contrast agent has a color intensity that is visible for a period of time after cell construction is completed when the electrolyte composition is both wet and dry, such as can occur on the outer surface of a cell container.

The components of the electrolyte composition can be combined in generally any order. However, in a preferred embodiment the contrast agent is added to an electrolyte composition comprising a solute and solvent in an effective amount in order to provide the desired color intensity to the electrolyte composition. Preferably the contrast agent is added to the electrolyte composition prior to the composition being introduced into an electrochemical cell container.

In another embodiment, the contrast agent is incorporated into the cell by other means: incorporation in one or more electrode mixes, added to the cell as a solid or solution other than the electrolyte.

If the electrolyte is added to the cell in multiple stages, the contrast agent could be incorporated into one or more shots. For example, it may be advantageous to add it to the last shot so that the concentration in the free electrolyte not absorbed into the electrode structures is higher. One could use different contrast agents to signal where in the production process leakage/contamination was occurring.

Additionally, multiple contrast agents could be used to effectively color-code electrolytes used in production and to help eliminate workers using the wrong electrolyte for a particular cell assembly. In particular, this approach could be used to help discriminate among electrolyte types used for a particular cell construction or between the first and second shot electrolyte types, if they had a different composition. In another embodiment, different colors could be used to identify which machines were used to make a particular cell, further aiding in tracking and resolving production issues associated with one or more of the pieces of equipment. As used herein, “color” may be differentiated by ambient light and/or by other more refined light sources that may or may not be discernible to the human eye.

As indicated hereinabove, in some embodiments of the present invention, the color intensity of the electrolyte composition including the contrast agent changes from a first color intensity to a second color intensity over time. Said time ranges generally from about 1 hour to about 3 months, 12 hours to about 2 months and preferably from about 2 days to about 1 month. The color intensity of the contrast agents of the invention should be suitable that the electrolyte composition, either when liquid or dried, for example in salt form, should be detectable on an outer surface of the cell container by one or more of an eye and an optical device, for example a camera. Several methods can be utilized for detecting the presence of the electrolyte composition on an outer surface of a container of an electrochemical cell. In various embodiments, the contrast agent-containing electrolyte is detected under ambient light conditions, but a visible, UV or other specialized light source can be helpful and possibly even necessary to easily detect the electrolyte or its residue. In addition, it may be advantageous to also use fluorescence in the contrast agents described above, whereby one shines a light of one frequency (usually in the UV region) so that the dye absorbs that frequency and responds by emitting light at a different or lower frequency (usually in the visible range). In any of these methods, only minute amounts of the material may be required, and the color can be extremely intense (in fact, in certain UV light applications, fluorescent dyes can make objects actually glow). Such lights, and the corresponding optical systems that may be used in conjunction therewith, appropriate for use in these embodiments are available from Cognex Corporation of Natick, Mass., U.S.A., Advanced Illumination, Inc. of Rochester, Vt., U.S.A. and others.

In embodiments employing special light sources, the electrolyte can appear colored only under the light source, and thus does not advertise any leakage or contamination to the consumer while making it readily detectable to the manufacturer. Use of a contrast agent whose color and/or intensity changes or fades possesses the same advantage. The light source can be applied in a pulsed or flashing mode, in which case the response detection may be synchronized to the frequency of the pulsed light; thereby further improving sensitivity and selectivity.

In a first step, the electrolyte composition is added to the electrochemical cell container. In one embodiment, a nonaqueous electrolyte composition is added to the container containing positive and negative electrodes, preferably in the form of a jellyroll or other electrode arrangement. The cell can be closed and sealed using any suitable process. Such processes may include, but are not limited to, crimping, redrawing, colleting and combinations thereof For example, for the cell in FIG. 1, a bead is formed in the can after the electrodes and insulator cone are inserted, and the gasket and cover assembly (including the cell cover, contact spring and vent bushing) are placed in the open end of the can. The cell is supported at the bead while the gasket and cover assembly are pushed downward against the bead. The diameter of the top of the can above the bead is reduced with a segmented collet to hold the gasket and cover assembly in place in the cell. After the electrolyte composition comprising the contrast agent is dispensed into the cell through the apertures in the vent bushing and cover, a vent ball is inserted into the bushing to seal the aperture in the cell cover. A PTC device and a terminal cover are placed onto the cell over the cell cover, and the top edge of the can is bent inward with a crimping die to hold and retain the gasket, cover assembly, PTC device and terminal cover and complete the sealing of the open end of the can by the gasket. After the electrochemical cell has been sealed, the outer surface of the electrochemical cell is inspected to determine if the electrolyte composition is present on the outer surface.

Inspection of the outer surface can be made visually utilizing the human eye, or an optical system. In one embodiment, the optical system uses a camera in ambient or other light to determine if the electrolyte composition in wet or dry form is present on the outer surface of the cell. In addition to ambient light or in place of ambient light, ultraviolet light can be utilized in conjunction with an optical system to inspect the outer surface of the electrochemical cell. By inspecting the electrochemical cell after sealing, electrolyte leakage or spillage of the electrolyte composition including the contrast agent can be detected on the outer surface and dealt with accordingly, such as by removing the contaminated cells from production prior to receipt by the retailer or consumer, cleaning off contaminated cells by washing or wiping down the cell. In cases of leakage, the cell is usually scrapped but could optionally be reclaimed and/or reworked.

The nonaqueous electrolyte composition in one embodiment of the present invention, including the contrast agent, contains water only in very small quantities as a contaminant (e.g., no more than about 500 parts per million by weight, depending on the electrolyte salt being used). Any nonaqueous electrolyte suitable for use with lithium and active cathode material may be used. The electrolyte contains one or more solutes, e.g. electrolyte salts dissolved in an organic solvent. Because the electrolyte is the primary media for ionic transfer in a Li/FeS₂ cell, selection of an appropriate solvent and solute combination is critical to optimizing the performance of the cell. Moreover, the solute and solvents selected for the electrolyte must possess appropriate miscibility and viscosity for the purposes of manufacture and use of the resulting cell, while still delivering appropriate discharge performance across the entire spectrum of temperatures potentially experienced by batteries (i.e., about −40° C. to 90° C.).

Miscibility and viscosity of the solvents and the electrolyte is key to the manufacturing and operational aspects of the battery. All solvents used in the blend must be completely miscible to insure a homogeneous solution. Similarly, in order to facilitate high volume production, the solvents should ideally possess a sufficiently low viscosity to flow and/or be dispensed quickly.

Additionally, the solvents and the electrolyte must possess a boiling point appropriate to the temperature range in which the battery will most likely be exposed and stored (e.g., −40° C. to 90° C.). More specifically, the solvent(s) must be sufficiently non-volatile to allow for safe storage and operation of the battery within this stated temperature range. Similarly, the solvents and the electrolyte must not react with the electrode materials in a manner that degrades the electrodes or adversely affects performance of the battery upon discharge. Suitable organic solvents that have been or may be used in Li/FeS₂ cells have included one or more of the following: 1,3-dioxolane; 1,3-dioxolane based ethers (e.g., alkyl- and alkoxy-substituted DIOX, such as 2-methyl-1,3-dioxolane or 4-methyl-1,3-dioxolane, etc.); 1,2-dimethoxyethane; 1,2-dimethoxyethane-based ethers (e.g., diglyme, triglyme, tetraglyme, ethyl glyme, etc.); ethylene carbonate; propylene carbonate; 1,2-butylene carbonate; 2,3-butylene carbonate; vinylene carbonate; dimethyl carbonate; diethyl carbonate; ethyl methyl carbonate; methyl formate; γ-butyrolactone; sulfolane; acetonitrile; N,N-dimethyl formamide: N,N-dimethylacetamide; N,N-dimethylpropyleneurea; 1,1,3,3-tetramethylurea; beta aminoenones; beta aminoketones; methyltetrahydrofurfuryl ether; diethyl ether; tetrahydrofuran; 2-methyl tetrahydrofuran; 2-methoxytetrahydrofuran; 2,5-dimethoxytetrahydrofuran; 3-methyl-2-oxazolidinone; 3,5-dimethylisoxazole (“DMI”); 1-ethoxy-2-methoxypropane; 1,2-dimethoxypropane; and 1,2-dimethoxypropane-based compounds. Additionally, other solvents may act as additives to impart further characteristics upon a particular electrolyte; for example, small amounts of pyridine, triethylamine or other organic bases may be used to control polymerization of the solvent(s). For cells requiring aqueous electrolytes, any number of solutions containing hydroxide (preferably potassium, sodium or lithium hydroxide(s) and the like), chloride (preferably ammonium or zinc chloride and the like) or acid (preferably sulfuric and the like), may be employed.

Salts should be nearly or completely soluble with the selected solvent(s) and, as with the discussion of solvent characteristics above, without any degradation or adverse effects. Examples of typical salts used in Li/FeS₂ cells include LiI (“lithium iodide”), LiCF₃SO₃ (“lithium trifluoromethanesulfonate or lithium triflate”), LiClO₄ (“lithium perchlorate”), Li(CF₃SO₂)₂N (“lithium bis(trifluorosulfonyl)imide or lithium imide”), Li(CF₃CF₂SO₂)₂N and Li(CF₃SO₂)₃C. Other potential candidates are lithium bis(oxalato)borate, lithium bromide, lithium hexafluorophosphate, and lithium hexafluoroarsenate. Potassium analogs of these salts may also be used, as a partial or complete replacement for their lithium analogs. Two key aspects of salt selection are that they do not react with the housing, electrodes, sealing materials or solvents and that they do not degrade or precipitate out of the electrolyte under the typically expected conditions to which the battery will be exposed and expected to operate (e.g., temperature, electrical load, etc.). It is possible to use more than one solute to maximize certain aspects of performance.

Notably, unless noted to the contrary, the concentration of the solutes relative to the solvents as described herein is best expressed as moles of solute per kilogram of solvent (molality). Molality of a solution remains constant irrespective of the physical conditions like temperature and pressure, whereas the volume of some solvents typically increases with in temperature thereby yielding a decrease in molarity (i.e., moles per liter solution), although this effect is usually small.

Lithium iodide is the preferred solute for primary nonaqueous cells with a cell voltage below 2.8V, although other solutes provided to this solvent blend would be expected to exhibit similar benefits (including but not limited to lithium perchlorate, lithium triflate, lithium imide and the like). The preferred solute concentration is about 0.75 molal.

### Other Cell Components

The cell container is often a metal can with a closed bottom such as the can in FIG. 1. The can material will depend in part of the active materials and electrolyte used in the cell. A common material type is steel. For example, the can may be made of steel, plated with nickel on at least the outside to protect the outside of the can from corrosion. The type of plating can be varied to provide varying degrees of corrosion resistance or to provide the desired appearance. The type of steel will depend in part on the manner in which the container is formed. For drawn cans the steel can be a diffusion annealed, low carbon, aluminum killed, SAE 1006 or equivalent steel, with a grain size of ASTM 9 to 11 and equiaxed to slightly elongated grain shape. Other steels, such as stainless steels, can be used to meet special needs. For example, when the can is in electrical contact with the cathode, a stainless steel may be used for improved resistance to corrosion by the cathode and electrolyte.

The cell cover can be metal. Nickel plated steel may be used, but a stainless steel is often desirable, especially when the cover is in electrical contact with the cathode. The complexity of the cover shape will also be a factor in material selection. The cell cover may have a simple shape, such as a thick, flat disk, or it may have a more complex shape, such as the cover shown in FIG. 1. When the cover has a complex shape like that in FIG. 1, a type 304 soft annealed stainless steel with ASTM 8-9 grain size may be used, to provide the desired corrosion resistance and ease of metal forming. Formed covers may also be plated, with nickel for example.

The terminal cover should have good resistance to corrosion by water in the ambient environment, good electrical conductivity and, when visible on consumer batteries, an attractive appearance. Terminal covers are often made from nickel plated cold rolled steel or steel that is nickel plated after the covers are formed. Where terminals are located over pressure relief vents, the terminal covers generally have one or more holes to facilitate cell venting.

The gasket is made from any suitable thermoplastic material that provides the desired sealing properties. Material selection is based in part on the electrolyte composition. Examples of suitable materials include polypropylene, polyphenylene sulfide, tetrafluoride-perfluoroalkyl vinylether copolymer, polybutylene terephthalate and combinations thereof. Preferred gasket materials include polypropylene (e.g., PRO-FAX® 6524 from Basell Polyolefins in Wilmington, Del., USA) and polyphenylene sulfide (e.g., XTEL™ XE3035 or XE5030 from Chevron Phillips in The Woodlands, Tex., USA). Small amounts of other polymers, reinforcing inorganic fillers and/or organic compounds may also be added to the base resin of the gasket.

The gasket may be coated with a sealant to provide the best seal. Ethylene propylene diene terpolymer (EPDM) is a suitable sealant material, but other suitable materials can be used.

If a ball vent is used, the vent bushing is made from a thermoplastic material that is resistant to cold flow at high temperatures (e.g., 75° C.). The thermoplastic material comprises a base resin such as ethylene-tetrafluoroethylene, polybutylene terephthlate, polyphenylene sulfide, polyphthalamide, ethylene-chlorotrifluoroethylene, chlorotrifluoroethylene, perfluoro-alkoxyalkane, fluorinated perfluoroethylene polypropylene and polyetherether ketone. Ethylene-tetrafluoroethylene copolymer (ETFE), polyphenylene sulfide (PPS), polybutylene terephthalate (PBT) and polyphthalamide are preferred. The resin can be modified by adding a thermal-stabilizing filler to provide a vent bushing with the desired sealing and venting characteristics at high temperatures. The bushing can be injection molded from the thermoplastic material. TEFZEL® HT2004 (ETFE resin with 25 weight percent chopped glass filler), polyphthalamide (e.g., AMODEL® ET 10011 NT, from Solvay Advanced Polymers, Houston, Tex.) and polyphenylene sulfide (e.g., e.g., XTEL™ XE3035 or XE5030 from Chevron Phillips in The Woodlands, Tex., USA) are preferred thermoplastic bushing materials.

The vent ball itself can be made from any suitable material that is stable in contact with the cell contents and provides the desired cell sealing and venting characteristic. Glasses or metals, such as stainless steel, can be used. In the event a foil vent is utilized in place of the vent ball assembly described above (e.g., pursuant to U.S. Patent Application Publication No. 2005/0244706 herein incorporated by reference), the above referenced materials may still be appropriately substituted.

Any number or combination of the aforementioned components may be treated or provided with a coating so as to impart additional desired characteristics to cell. By way of example rather than limitation, the seal member(s) (e.g., the gasket, vent, cell cover, etc.) may be coated with a composition to inhibit the ingress or egress of moisture or electrolyte solvents therethrough. The interior of the container may also be coated to improve cell performance and/or manufacture. To the extent that such coatings or treatments are utilized, it is possible to introduce the contrast agent into the cell as part of this/these coating(s) as an additional or alternative embodiment of the invention, so long as the component containing the contrast agent remains exposed to an internal surface of the cell, thereby allowing dissolution and dispersion of the contrast agent with the electrolyte composition.

### Electrodes

The anode comprises a strip of lithium metal, sometimes referred to as lithium foil. The composition of the lithium can vary, though for battery grade lithium, the purity is always high. The lithium can be alloyed with other metals, such as aluminum, to provide the desired cell electrical performance or handling ease, although the amount of lithium in any alloy should nevertheless be maximized. Appropriate battery grade lithium-aluminum foil, containing 0.5 weight percent aluminum, is available from Chemetall Foote Corp., Kings Mountain, N.C., USA.

Other anode materials may be possible, including sodium, potassium, zinc, magnesium and aluminum, either as co-anodes, alloying materials or distinct, singular anodes. Anodes such as carbon, silicon, tin, copper and their alloys, as well as lithium titanate spinel, that have been reported and in some cases commonly used in lithium-ion and other primary or secondary cells can also be used. Ultimately, the selection of an appropriate anode material will be influenced by the compatibility of that anode with electrolyte and performance in the cell. The physical attributes of the alloy may also be important, especially for a spiral wound cell, because the alloy has to have enough flexibility to be wound. The amount that the anode stretches during such winding can also be important. Thus, the physical properties of the alloy need to be matched against the processes used to make the cell.

As in the cell in FIG. 1, a separate current collector (i.e., an electrically conductive member, such as a metal foil, onto which the anode is welded/coated or an electrically conductive strip running along the length of the anode) may not needed for the anode, since lithium has a high electrical conductivity. By not utilizing such a current collector, more space is available within the container for other components, such as active materials. Anode current collectors may be made of copper and/or other appropriate high conductivity metals so as long as they are stable when exposed to the other interior components of the cell (e.g., electrolyte), and therefore also affect cost. Alternatively, when the anode is provided in a bobbin-style construction, the current collector may be nail, conductive wire or other similar structure.

In jellyroll and prismatic constructions, the electrical connection should be maintained between each of the electrodes and the opposing terminals proximate to or integrated with the housing. An electrical lead 36 can be made from a thin metal strip connecting the anode or negative electrode to one of the cell terminals (the can in the case of the FR6 cell shown in FIG. 1). When the anode includes such a lead, it is oriented substantially along a longitudinal axis of the jellyroll electrode assembly and extends partially along a width of the anode. This may be accomplished embedding an end of the lead within a portion of the anode or by simply pressing a portion such as an end of the lead onto the surface of the lithium foil. The lithium or lithium alloy has adhesive properties and generally at least a slight, sufficient pressure or contact between the lead and electrode will weld the components together. The negative electrode may be provided with a lead prior to winding into a jellyroll configuration. The lead may also be connected via other appropriate welds.

The metal strip comprising the lead 36 is often made from nickel or nickel plated steel with sufficiently low resistance (e.g., generally less than 15 mΩ/cm and preferably less than 4.5 mΩ/cm) in order to allow sufficient transfer of electrical current through the lead and have minimal or no impact on service life of the cell. A preferred material is 304 stainless steel. Examples of other suitable negative electrode lead materials include, but are not limited to, copper, copper alloys, for example copper alloy 7025 (a copper, nickel alloy comprising about 3% nickel, about 0.65% silicon, and about 0.15% magnesium, with the balance being copper and minor impurities); and copper alloy 110; and stainless steel. Lead materials should be chosen so that the composition is stable within the electrochemical cell including the electrolyte.

The cathode may be ring molded, provided as a pellet or in the form of a strip that comprises a current collector and a mixture that includes one or more electrochemically active materials, usually in particulate form. Iron disulfide (FeS₂) is a preferred active material although the invention is applicable to cathode materials such as MnO₂, FeS, CuO, CuO₂, transition metal polysulfides, nickel oxyhydroxides, oxides of bismuth (e.g., Bi₂O₃, etc.), and oxides typically used in lithium ion cells (i.e., LiFePO₄, LiCoO₂, LiMn_{1/3}Ni_{1/3}Co_{1/3}O₂, Li_{1.1}(Mn_{1/3}Ni_{1/3}Co_{1/3})_{0.9}O₂, LiNi_{0.8}Co_{0.15}Al_{0.05}O₂, LiMn_{1/2}Co_{1/2}O₂, LiMn₂O₄ and the like). Additionally or alternatively, “doped” materials, comprising any one or combination of the aforementioned cathode active materials, with small amounts of various metals or other materials inserted or chemically bonded into the crystalline structure in order to improve the overall performance of the resulting cell, may also be used.

In the preferred Li/FeS₂ cell, the active material comprises greater than 50 weight percent FeS₂. The cathode can also contain one or more additional active materials mentioned above, depending on the desired cell electrical and discharge characteristics. More preferably the active material for a Li/FeS₂ cell cathode comprises at least 95 weight percent FeS₂, yet more preferably at least 99 weight percent FeS₂, and most preferably FeS₂ is the sole active cathode material. FeS₂ having a purity level of at least 95 weight percent is available from Washington Mills, North Grafton, Mass., USA; Chemetall GmbH, Vienna, Austria; and Kyanite Mining Corp., Dillwyn, Va., USA. A more comprehensive description of the cathode, its formulation and a manner of manufacturing the cathode is provided below.

The current collector in the preferred cell may be disposed within or imbedded into the cathode surface, or the cathode mixture may be coated onto one or both sides of a thin metal strip. Aluminum is a commonly used material. The current collector may extend beyond the portion of the cathode containing the cathode mixture. This extending portion of the current collector can provide a convenient area for making contact with the electrical lead connected to the positive terminal. It is desirable to keep the volume of the extending portion of the current collector to a minimum to make as much of the internal volume of the cell available for active materials and electrolyte. Additionally or alternatively, it may be possible to rely upon the conductive qualities of the container to act as a current collector.

The cathode is electrically connected to the positive terminal of the cell. This may be accomplished with an electrical lead, often in the form of a thin metal strip or a spring, as shown in FIG. 1, although welded connections are also possible. The lead is often made from nickel plated stainless steel. Still another embodiment may utilize a connection similar to that disclosed in United States Publication No. 2007/0007183 and/or United States Publication No. 2008/0254343, both of which are commonly assigned to the assignee of this application and incorporated by reference herein. Notably, to the extent a cell design may utilize one of these alternative electrical connectors/current limiting devices, the use of a PTC may be avoided. In the event an optional current limiting device, such as a standard PTC, is utilized as a safety mechanism to prevent runaway discharge/heating of the cell, a suitable PTC is sold by Tyco Electronics in Menlo Park, Calif., USA. Other alternatives are also available.

While the contrast agent described above is preferably provided to the cell as part of the electrolyte composition, it is also possible to incorporate the contrast agent into the electrode(s) as an additional or alternative measure. That is, the contrast agent may be included as part of the anode and/or cathode formulation, or it may be applied as a separate coating on one or both of these electrodes. In doing so, care must be taken to insure that the contrast agent has sufficient exposure to the electrolyte after assembly of the cell so as to permit dispersion of the contrast agent within the cell to effect subsequent detection (presuming, of course, the container displays unwanted leakage).

### Separator

When nonaqueous electrolytes are used, the separator may be a thin microporous membrane that is ion-permeable and electrically nonconductive. It is capable of holding at least some electrolyte within the pores of the separator. The separator is disposed between adjacent surfaces of the anode and cathode to electrically insulate the electrodes from each other. Portions of the separator may also insulate other components in electrical contact with the cell terminals to prevent internal short circuits. Edges of the separator often extend beyond the edges of at least one electrode to insure that the anode and cathode do not make electrical contact even if they are not perfectly aligned with each other. However, it is desirable to minimize the amount of separator extending beyond the electrodes.

To provide good high power discharge performance it is desirable that the separator have the characteristics (pores with a smallest dimension of at least 0.005 μm and a largest dimension of no more than 5 μm across, a porosity in the range of 30 to 70 percent, an area specific resistance of from 2 to 15 ohm-cm² and a tortuosity less than 2.5) disclosed in U.S. Pat. No. 5,290,414, issued Mar. 1, 1994, and hereby incorporated by reference.

Suitable separator materials should also be strong enough to withstand cell manufacturing processes as well as pressure that may be exerted on the separator during cell discharge without tears, splits, holes or other gaps developing that could result in an internal short circuit. To minimize the total separator volume in the cell, the separator should be as thin as possible, preferably less than 25 μm thick, and more preferably no more than 22 μm thick, such as 20 μm or 16 μm. A high tensile stress is desirable, preferably at least 800, more preferably at least 1000 kilograms of force per square centimeter (kgf/cm²). For an FR6 type cell the preferred tensile stress is at least 1500 kgf/cm² in the machine direction and at least 1200 kgf/cm² in the transverse direction, and for a FR03 type cell the preferred tensile strengths in the machine and transverse directions are 1300 and 1000 kgf/cm², respectively. Preferably the average dielectric breakdown voltage will be at least 2000 volts, more preferably at least 2200 volts and most preferably at least 2400 volts. The preferred maximum effective pore size is from 0.08 μm to 0.40 μm, more preferably no greater than 0.20 μm. Preferably the BET specific surface area will be no greater than 40 m²/g, more preferably at least 15 m²/g and most preferably at least 25 m²/g. Preferably the area specific resistance of the electrolyte-separator combination is no greater than 4.3 ohm-cm², more preferably no greater than 4.0 ohm-cm², and most preferably no greater than 3.5 ohm-cm². These properties are described in greater detail in U.S. Patent Publication No. 2005/0112462, which is hereby incorporated by reference.

Separator membranes for use in lithium batteries are often made of polypropylene, polyethylene or ultrahigh molecular weight polyethylene, with polyethylene being preferred for primary nonaqueous cells. The separator can be a single layer of biaxially oriented microporous membrane, or two or more layers can be laminated together to provide the desired tensile strengths in orthogonal directions. A single layer is preferred to minimize the cost. Suitable single layer biaxially oriented polyethylene microporous separator is available from Tonen Chemical Corp., available from EXXON Mobile Chemical Co., Macedonia, N.Y., USA. Suitable separators with similar properties are also available from Entek Membranes in Lebanon, Oreg., USA.

When aqueous electrolytes are used, any type of known paper, woven, non-woven, fibrous and/or other materials may be used. Examples of such materials may be found in U.S. Patent Publication Nos. 2001/0012580, 2002/0071915 and 2003/0082443, all of which are hereby incorporated by reference.

The above description is particularly relevant to cylindrical Li/FeS₂ cells, such as FR6 and FR03 types, as defined in International Standards IEC 60086-1 and IEC 60086-2, published by the International Electrotechnical Commission, Geneva, Switzerland. However, the invention may also be adapted to other cell sizes and shapes and to cells with other electrode assembly, housing, seal and pressure relief vent designs. Other cell types in which the invention can be used include primary and rechargeable nonaqueous cells, such as lithium/manganese dioxide and lithium ion cells. The electrode assembly configuration can also vary. For example, it can have spirally wound electrodes, as described above, folded electrodes, or stacks of strips (e.g., flat plates). The cell shape can also vary, to include cylindrical and prismatic shapes, for example. Other cell chemistries such as, but not limited to, Zn/MnO₂, Zn/air, Li/air, Ni/metal hydride, Li/SO₂, Li/AgCl, Li/V₂O₅, Li/MnO₂, Li/Bi₂O₃, LiCFₓ, lithium ion, Li/CuO, and Li/SOCl₂ can be utilized. These batteries could have a nominal voltage higher than 1.50 V such as 2.0, 3.0 or 4.1 V.

### EXAMPLES

75 microliters of contrast agent-containing electrolyte composition was applied to sealed dummy electrochemical cell containers at the vent ball bushing and cell cover interface to replicate a wet top condition. The electrolyte was 0.75 molal LiI in 69.4:30.4:0.2 blend of 1,3-dioxolane:1,2-dimethoxyethane:3,5-dimethylisoxazole. The azo compounds Eriochrome Black T and RD-38 were separately utilized as contrast agents. Due to the presence of the contrast agent in the electrolyte, the color intensity of the electrolyte composition was ascertainable under ambient visual light. The indicated cells were viewed by an optical system, in particular a Vision system, in both wet and dry, salt residue states. When compared to a control electrolyte formulation including no contrast agent, each of the contrast agent-containing electrolyte compositions were detected by the Vision system in the wet state. Detection of LiI salt and contrast agent left as dried electrolyte composition residue on the cell cover were even more detectable than the wet state samples.

Five separate lots of Li/FeS₂ FR6-sized electrochemical cells were constructed utilizing spirally wound electrodes of lithium-aluminum alloy and iron disulfide slurry coated onto an aluminum foil collector separated by a polyethylene separator. The base electrolyte was the 0.75 molal LiI in 69.4:30.4:0.2 blend of 1,3-dioxolane:1,2-dimethoxyethane:3,5-dimethylisoxazole blend and the only variable between the cells was the contrast agent as indicated below.

TABLE 1

| Lot No. | Contrast Agent | Amount |
|---|---|---|
| 1 | Eriochrome Black T | 200 ppm |
| 2 | RD-58 | 200 ppm |
| 3 | Eriochrome Black T | 600 ppm |
| 4 | RD-58 | 600 ppm |
| 5 | None (control) | None |

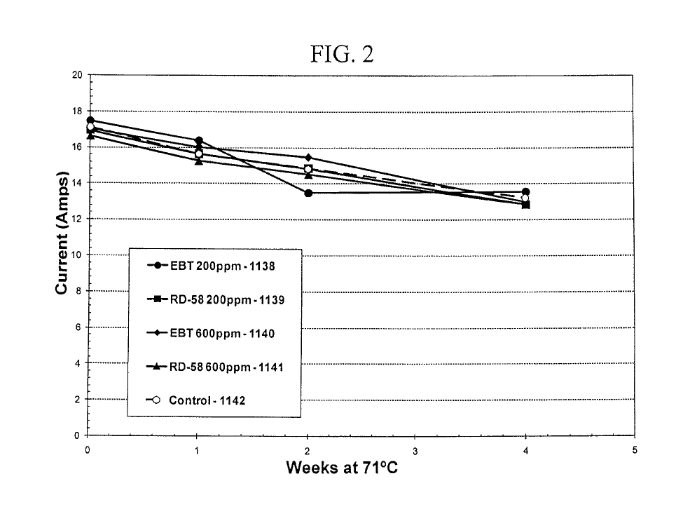

The cells of Lot 5 were the control cells that were free of the contrast agent. Both RD-58 and Eriochrome Black T are azo compounds. All of the cells gave good performance when fresh and after high temperature storage. FIG. 2 shows the excellent amperage of the cells when periodically removed from 71° C. ovens and tested. Table 2 shows the minutes to a 1.05V cut on a standard digital still camera (DSC) test. The DSC test is considered a “high rate” test, defined by the American National Standards Institute, and is indicative of cell performance for high rate uses such as in devices, for example a digital camera. The DSC test cycles the electrochemical cell utilizing two pulses, the first pulse at 1500 mW for 2 seconds followed by the second pulse at 650 mW for 28 seconds. The pulse sequence is repeated 10 times, followed by a rest period for 55 minutes. Afterwards, the pulse sequence and rest period are repeated to a predetermined cut-off voltage, 1.05 volts for the test performed herein. All of the lots with the contrast agent (i.e., Lots 1-4) gave comparable performance to the control lot (i.e., Lot 5), even after 2 months at 71° C. This demonstrates the excellent stability of the contrast agents in the batteries.

TABLE 2

| | | | | | |
|---|---|---|---|---|---|
| Lot | Average | Stdev. | RSD | Cells Tested | Cells Excluded |

Fresh

| | | | | | |
|---|---|---|---|---|---|
| Lot 1 | 328 | 3 | 0.9% | 10 | 0 |
| Lot 2 | 328 | 4 | 1.2% | 10 | 0 |
| Lot 3 | 327 | 4 | 1.3% | 10 | 0 |
| Lot 4 | 324 | 3 | 0.9% | 10 | 0 |
| Lot 5 | 327 | 4 | 1.3% | 10 | 0 |

1 Month at 71° C.

| | | | | | |
|---|---|---|---|---|---|
| Lot 1 | 324 | 5 | 1.6% | 10 | 0 |
| Lot 2 | 325 | 5 | 1.5% | 10 | 0 |
| Lot 3 | 327 | 4 | 1.3% | 10 | 0 |
| Lot 4 | 322 | 3 | 0.8% | 10 | 0 |
| Lot 5 | 323 | 2 | 0.7% | 10 | 0 |

2 Month at 71° C.

| | | | | | |
|---|---|---|---|---|---|
| Lot 1 | 319 | 8 | 2.5% | 10 | 0 |
| Lot 2 | 315 | 4 | 1.2% | 10 | 0 |
| Lot 3 | 324 | 3 | 1.0% | 10 | 0 |
| Lot 4 | 315 | 15 | 4.8% | 10 | 0 |
| Lot 5 | 318 | 4 | 1.2% | 10 | 0 |

In accordance with the patent statutes, the best mode and preferred embodiment have been set forth, the scope of the invention is not limited thereto, but rather by the scope of the attached claims. The examples above are merely considered to be specific embodiments of the invention disclosed herein.

Thus, as described herein, the invention may specifically include any one or combination of the following features:
an electrolyte composition suitable for use in an electrochemical cell and/or an electrochemical cell having a container, a positive electrode and a negative electrode;
a contrast agent comprising an azo compound;
wherein the electrolyte composition includes at least one solvent and solute;
wherein the electrolyte composition includes at least one nonaqueous solvent;
wherein the contrast agent has the formulae R₁—N═N—R₂ or R(—N═N—R₂)ₙ—N═N—R₃, in which n is between 1 and 5 and R₁, R₂, and R₃ each comprise one or more aliphatic groups, one or more aryl groups, or one or more arylalkyl groups or a combination thereof, said aliphatic, aryl and arylalkyl groups each optionally containing one or more substituent groups;
wherein said aliphatic group is linear or branched and has from 1 to 15 carbon atoms, wherein said aryl group has from 5 to 20 carbon atoms;
wherein said substituent group is present and includes one or more selected from the group consisting of: a hydroxyl group, a carbonyl group, an acid group, an ester group, an amide group, an amine group, a nitrile group, a nitro group, a halogen, a peroxy group, or a salt thereof;
wherein at least one of R₁, R₂, and R₃ is a naphthalenol group;
wherein said azo compound comprises at least one selected from:

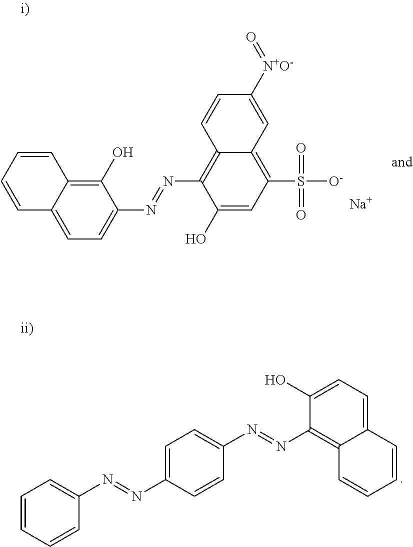

wherein said contrast agent is present in an amount from 10 to 50,000 ppm by weight of the electrolyte composition;
wherein the nonaqueous solvent comprises 1,3-dioxolane;
wherein the amount of the contrast agent is from about 100 to about 5,000 ppm by weight;
wherein the electrolyte composition exhibits a first color intensity upon combination of the contrast agent and the electrolyte mixture whereafter the electrolyte composition is a capable of exhibiting a second color intensity at a time after said combination;
wherein the second color intensity is achieved when the time is at least one hour to three months;
wherein said contrast agent includes a naphthalenol group;
wherein the negative electrode comprises lithium;
wherein the positive electrode comprises at least one selected from the group consisting of: iron sulfide, iron disulfide and metal doped derivatives thereof;
wherein the contrast agent is incorporated in a coating deposited on at least a portion of the container or an internal component of the cell; and/or
wherein the contrast agent is incorporated on or in at least one of the positive electrode and the negative electrode.

Alternatively, the invention may also include any one or combination of the following features:
a method of manufacturing an electrochemical cell to detect the unwanted presence of electrolyte composition on the container of the cell;
providing a contrast agent including an azo compound to the electrochemical cell;
providing a contrast agent having a first color intensity that changes to a second color intensity over a selected period of time after the contrast agent is exposed to the electrolyte composition;
sealing the electrochemical cell;
inspecting the cell to determine if the electrolyte composition is present on the outer surface of the container;
taking corrective measures after determining the presence of electrolyte composition, said corrective measures including either washing the container to remove the electrolyte composition or discarding the cell;
wherein the contrast agent is provided to the cell as part of an electrolyte composition;
wherein the electrolyte composition comprises at least one nonaqueous solvent;
wherein the contrast agent is provided to the cell as part of at least one selected from the group consisting of: a coating on the container, a negative electrode composition, a positive electrode composition and a coating on an internal component of the cell;
wherein the inspecting the cell further comprises using a light source having a wavelength to determine the presence of electrolyte composition on the outer surface of the container;
wherein the wavelength of the light source is ultraviolet light or ambient light;
wherein the contrast agent responds to the light source by emitting light at a different wavelength than the light source;
wherein the contrast agent is selected to change from a first color intensity to a second color intensity over a selected period of time after the contrast agent is introduced to the electrolyte composition;
wherein the second color intensity cannot be detected under ambient conditions;
wherein the selected period of time is between one hour to three months;
wherein the light source is pulsed at a frequency and the determination of presence of electrolyte is synchronized to the frequency of the pulsed light;
wherein the inspecting the cell is conducted using an optical device;
wherein a plurality of contrast agents are provided;
wherein each contrast agent provided to the cell is selected to possess a distinct color to discriminate between separate manufacturing processes for the cell; and/or
wherein the contrast agent is provided at a concentration between 100 to 5,000 parts per million by weight of electrolyte composition.

What is claimed:

1. An electrolyte composition, comprising:
at least one solvent and solute suitable for use in an electrochemical cell; and,
a contrast agent comprising an azo compound.

2. The electrolyte composition according to claim 1, wherein the contrast agent has the formula R₁—N═N—R₂ or R(—N═N—R₂)ₙ—N═N—R₃, in which n is between 1 and 5 and R₁, R₂, and R₃ are each selected from the group consisting of: aliphatic groups, one or more aryl groups, or one or more arylalkyl groups or combinations thereof, said aliphatic, aryl and arylalkyl groups optionally containing one or more substituent groups.

3. The electrolyte composition according to claim 2, wherein said aliphatic group, when present, is linear or branched and has from 1 to 15 carbon atoms; wherein said aryl group, when present, has from 5 to 20 carbon atoms; and wherein said substituent group is present and includes one or more selected from the group consisting of: a hydroxyl group, a carbonyl group, an acid group, an ester group, an amide group, an amine group, a nitrile group, a nitro group, a halogen, a peroxy group, or a salt thereof.

4. The electrolyte composition according to claim 2, wherein at least one of R₁, R₂, and R₃ is a naphthalenol group

5. The electrolyte composition according to claim 1 wherein said azo compound comprises at least one selected from:

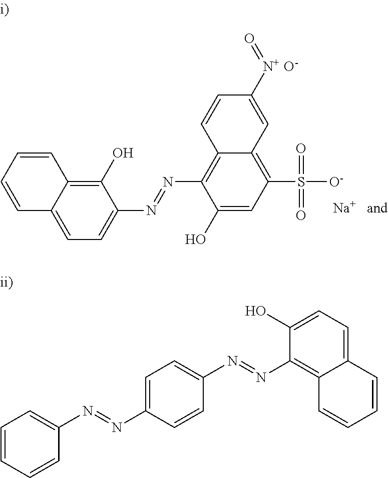

6. The electrolyte composition according to claim 1, wherein said contrast agent is present in an amount from 10 to 50,000 ppm by weight of the electrolyte composition.

7. The electrolyte composition according to claim 6, wherein the amount of the contrast agent is from about 100 to about 5,000 ppm by weight.

8. The electrolyte composition according to claim 1, wherein the composition exhibits a first color intensity upon combination of the contrast agent and the electrolyte mixture whereafter the electrolyte composition is a capable of exhibiting a second color intensity at a time after said combination.

9. The electrolyte composition according to claim 8, wherein the second color intensity is achieved when the time is at least one hour to three months and said contrast agent includes a naphthalenol group.

10. The electrolyte composition according to claim 1, wherein the solvent comprises a nonaqueous solvent and a solute comprising lithium.

11. The electrolyte composition according to claim 10, wherein the solvent comprises 1,3-dioxolane.

12. An electrochemical cell, comprising:
a container comprising a positive electrode, a negative electrode, a contrast agent comprising an azo compound and an electrolyte composition comprising at least one solvent and a solute.

13. An electrochemical cell according to claim 12, wherein the negative electrode comprises lithium.

14. An electrochemical cell according to claim 13, wherein the positive electrode comprises at least one selected from the group consisting of: iron sulfide, iron disulfide and metal doped derivatives thereof.

15. An electrochemical cell according to claim 12 wherein the contrast agent is incorporated in a coating deposited on at least a portion of the container or an internal component of the cell.

16. An electrochemical cell according to claim 12 wherein the contrast agent is incorporated on or in at least one of the positive electrode and the negative electrode.

17. A method of manufacturing an electrochemical cell to detect the presence of an electrolyte composition on an outer surface of a container of the cell, comprising the steps of:
providing a contrast agent including an azo compound to an electrochemical cell;
sealing the electrochemical cell; and
inspecting the cell to determine if the electrolyte composition is present on the outer surface of the container.

18. The method according to claim 17, wherein the contrast agent is provided to the cell as part of an electrolyte composition.

19. The method according to claim 18, wherein the electrolyte composition comprises at least one nonaqueous solvent.

20. The method according to claim 17, wherein the contrast agent is provided to the cell as part of at least one selected from the group consisting of: a coating on the container, a negative electrode composition, a positive electrode composition and a coating on an internal component of the cell.

21. The method according to claim 17, wherein the inspecting the outer surface of the cell further comprises using a light source having a wavelength to determine the presence of electrolyte composition on the outer surface of the container.

22. The method according to claim 21, wherein the wavelength of the light source is ultraviolet light or ambient light.

23. The method according to claim 21, wherein the contrast agent responds to the light source by emitting light at a different wavelength than the light source.

24. The method according to claim 21, wherein the light source is pulsed at a frequency and the determination of presence of electrolyte is synchronized to the frequency of the pulsed light.

25. The method according to claim 24, wherein the inspecting the cell is conducted using an optical device.

26. The method according to claim 17, wherein the inspecting the cell is conducted using an optical device.

27. The method according to claim 17, wherein a plurality of contrast agents are provided.

28. The method according to claim 27, wherein each contrast agent is selected to possess a distinct color to discriminate between separate manufacturing processes for the cell.

29. The method according to claim 18, wherein the contrast agent is provided at a concentration between 100 to 5,000 parts per million by weight of electrolyte composition.

30. The method according to claim 17, further comprising taking corrective measures after determining the presence of electrolyte composition, said corrective measures including either washing the container to remove the electrolyte composition or discarding the cell.

31. The method according to claim 17, wherein the contrast agent is selected to change from a first color intensity to a second color intensity over a selected period of time after the contrast agent is introduced to the electrolyte composition.

32. The method according to claim 31, wherein the selected period of time is between one hour to three months.

33. A method of manufacturing an electrochemical cell to detect the presence of an electrolyte composition on an outer surface of a container of the cell, comprising the steps of:
providing a contrast agent having a first color intensity that changes to a second color intensity over a selected period of time after the contrast agent is exposed to the electrolyte composition;
sealing the electrochemical cell; and
inspecting the cell to determine if the electrolyte composition is present on the outer surface of the container.

34. The method according to claim 33, wherein the contrast agent is provided to the cell as part of at least one selected from the group consisting of: a coating on the container, a negative electrode composition, a positive electrode composition and a coating on an internal component of the cell.

35. The method according to claim 33, wherein the second color intensity cannot be detected under ambient conditions.

36. The method according to claim 35, wherein the selected period of time is one hour to three months.
